(19) United States
(12) Patent Application Publication
(10) Pub. No.: US 2026/0044320 A1
(43) Pub. Date: Feb. 12, 2026

(54) METHOD FOR PROCESSING A CODE BASED ON A LARGE MODEL, ELECTRONIC DEVICE, AND STORAGE MEDIUM

(71) Applicant: BEIJING BAIDU NETCOM SCIENCE TECHNOLOGY CO., LTD., Beijing (CN)

(72) Inventors: Qian Liu, Beijing (CN); Xiaowei Wang, Beijing (CN); Xiying Wang, Beijing (CN); Huibin Zhao, Beijing (CN); Jingwei Yang, Beijing (CN); Xue Xiao, Beijing (CN); Murong Cai, Beijing (CN)

(73) Assignee: BEIJING BAIDU NETCOM SCIENCE TECHNOLOGY CO., LTD., Beijing (CN)

(21) Appl. No.: 19/359,214

(22) Filed: Oct. 15, 2025

(30) Foreign Application Priority Data
Nov. 15, 2024 (CN) 202411643678.1

(51) Int. Cl. G06F 8/35; G06F 8/33

(52) U.S. Cl. CPC G06F 8/35; G06F 8/33

(57) ABSTRACT

A method for processing a code based on a large model in a human-machine interaction system is performed by an electronic device and includes: obtaining a first dialog text for describing a code processing task; determining at least one of a newly added code file or an original code file as a target code file corresponding to the code processing task; inputting the first dialog text into a large model, and outputting, via the large model, a code processing result of the target code file and a second dialog text corresponding to the first dialog text; and displaying the code processing result and a target dialog text on an interaction interface, wherein the target dialog text comprises at least one of the first dialog text or the second dialog text.

### CROSS-REFERENCE TO RELATED APPLICATION

The present application is based upon and claims priority to Chinese Patent Application No. 2024116436781, filed on Nov. 15, 2024, the entire contents of which are incorporated herein by reference.

### TECHNICAL FIELD

The present disclosure relates to a field of artificial intelligence technology, specifically to fields of natural language processing, deep learning, and large model technology, and specifically to a method and an apparatus for processing a code based on a large model, an electronic device, a storage medium, and a computer program product.

### BACKGROUND

In the related art, during the code processing, a user typically needs to open a code file to be processed on a client, and manually process the opened code file. The user operation is complex and the efficiency of code processing is low, which results in a poor user experience in a code processing scenario.

### SUMMARY

According to a first aspect of the present disclosure, a method for processing a code based on a large model in a human-machine interaction system is performed by an electronic device, including: obtaining a first dialog text for describing a code processing task; determining at least one of a newly added code file or an original code file as a target code file corresponding to the code processing task; inputting the first dialog text into a large model, and outputting, via the large model, a code processing result of the target code file and a second dialog text corresponding to the first dialog text; and displaying the code processing result and a target dialog text on an interaction interface, in which the target dialog text includes at least one of the first dialog text or the second dialog text.

According to a second aspect of the present disclosure, an electronic device is applied in a human-machine interaction system. The electronic device includes a processor and a memory storing instructions executable by the processor. The processor is configured to obtain a first dialog text for describing a code processing task; determine at least one of a newly added code file or an original code file as a target code file corresponding to the code processing task; input the first dialog text into a large model, and output, via the large model, a code processing result of the target code file and a second dialog text corresponding to the first dialog text; and display the code processing result and a target dialog text on an interaction interface, in which the target dialog text includes at least one of the first dialog text or the second dialog text.

According to a third aspect of the present disclosure, a non-transitory computer-readable storage medium storing computer instructions, in which the computer instructions are configured to cause a computer to implement the method for processing a code based on a large model provided in the above first aspect.

### BRIEF DESCRIPTION OF THE DRAWINGS

The accompanying drawings are used for a better understanding of the disclosure and do not constitute a limitation of the disclosure.

FIG. 1 is a flowchart of a method for processing a code based on a large model according to an embodiment of the present disclosure.

FIG. 2 is a flowchart of a method for processing a code based on a large model according to another embodiment of the present disclosure.

FIG. 3 is a flowchart of a method for processing a code based on a large model according to another embodiment of the present disclosure.

FIG. 4 is a flowchart of a method for processing a code based on a large model according to another embodiment of the present disclosure.

FIG. 5 is a flowchart of a method for processing a code based on a large model according to another embodiment of the present disclosure.

FIG. 6 is a flowchart of a method for processing a code based on a large model according to another embodiment of the present disclosure.

FIG. 7 is a flowchart of a method for processing a code based on a large model according to another embodiment of the present disclosure.

FIG. 8 is a schematic diagram of a method for processing a code based on a large model according to an embodiment of the present disclosure.

FIG. 9 is a schematic diagram of an interaction interface according to an embodiment of the present disclosure.

FIG. 10 is a block diagram of an apparatus for processing a code based on a large model according to an embodiment of the present disclosure.

FIG. 11 is a block diagram of an electronic device according to an embodiment of the present disclosure.

### DETAILED DESCRIPTION

Exemplary embodiments of the disclosure are described hereinafter in conjunction with the accompanying drawings, which include various details of the embodiments of the disclosure in order to aid in understanding, and should be considered exemplary only. Accordingly, those skilled in the art should recognize that various changes and modifications may be made to the embodiments described herein without departing from the scope of the disclosure. Similarly, descriptions of well-known features and structures are omitted from the following description for the sake of clarity and brevity.

Artificial intelligence (AI) is a technical science that studies and develops theories, methods, technologies, and application systems for simulating, extending, and expanding human intelligence. Currently, the AI technology, with advantages of high automation, high accuracy, and low cost, has been widely applied.

Natural language processing (NLP) is a science that studies computer systems, especially the software system within the computer systems, capable of effectively realizing natural language communication, and is also an important direction in fields of computer science and artificial intelligence.

Deep learning (DL) is a new research direction in the field of machine learning (ML). It is a science that learns internal laws and representational levels of sample data, which enables machines to have analytical and learning abilities like humans and to recognize data such as texts, images, and sound. DL is widely used in speech and image recognition.

A large model refers to a machine learning model with a large parameter scale and high complexity, which requires a large amount of computing resources and storage spaces for training and storage, and often involves distributed computing and special hardware acceleration technologies. The large model has strong generalization and expression capabilities. The large model includes a large language model (LLM). The LLM refers to a deep learning model trained using a large amount of text data, which may generate natural language texts or understand meanings of language texts. The LLM may handle various natural language tasks, such as text classification, question and answer, and dialogue, and the LLM is an important path towards the AI.

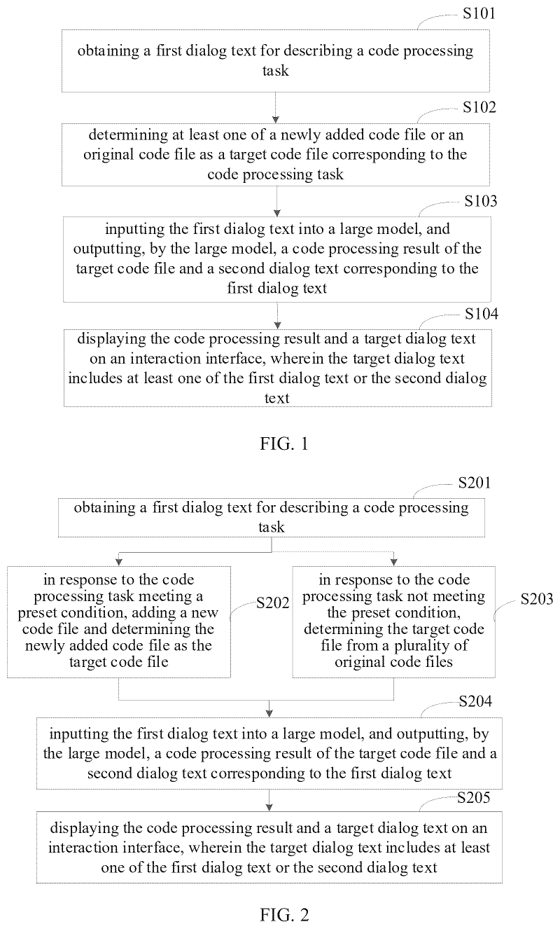

FIG. 1 is a flowchart of a method for processing a code based on a large model according to an embodiment of the present disclosure. As shown in FIG. 1, the method includes steps at S101 to S104.

At S101, a first dialog text for describing a code processing task is obtained.

It needs to be noted that an execution body of the method for processing a code based on a large model in the embodiments of the present disclosure may be a hardware device with a data information processing capability and/or software required to drive an operation of such hardware device. Optionally, the execution body may include a workstation, a server, a computer, a user terminal, and other smart devices. The user terminal includes, but is not limited to, a mobile phone, a computer, a smart voice interaction device, a smart home appliance, a vehicle-mounted terminal, etc.

It needs to be noted that a task type of the code processing task is not excessively limited. For example, it may include a code adjustment task (such as code addition, deletion, modification), a code testing task (such as code unit testing), a code verification task (such as code security verification), a code repair task (such as code vulnerability repair), etc. The code security verification includes code vulnerability detection, etc.

It needs to be noted that the first dialog text is a text composed of natural language, and the first dialog text is not excessively limited, for example, it may be composed of at least one language, such as Chinese, English, and so on.

For example, the first dialog text may include “Please help me add some logs to handle abnormal minutes”, “Please help me write a unit test code to improve test coverage”, “Please help me perform unit testing on xx1”, “Please help me perform vulnerability scanning on xx1”, “Please help me perform vulnerability repair on xx1”, etc, where “xx1” is used to represent a code file.

In an implementation, obtaining the first dialog text for describing the code processing task includes, in response to detecting an input operation for a dialog text, extracting the first dialog text from the input operation. For example, an input box for entering the dialog text may be displayed on an interaction interface. A user may perform the input operation for the dialog text within the input box. Correspondingly, in response to detecting the input operation for the dialog text, the first dialog text may be extracted from the input operation by the client.

In an implementation, obtaining the first dialog text for describing the code processing task includes collecting voice information of the user, performing text recognition on the voice information, and obtaining the first dialog text. For example, an icon for inputting the voice information may be displayed on the interaction interface. The user may click the above icon and speak. Correspondingly, in response to a click operation on the above icon, the voice information of the user may be collected by the client, the text recognition may be performed on the voice information to obtain the first dialog text.

At S102, at least one of a newly added code file or an original code file is determined as a target code file corresponding to the code processing task.

It needs to be noted that the target code file refers to a code file to be processed in the code processing task. The target code file may include at least one of the newly added code file and the original code file, and there is at least one target code file. The newly added code file refers to a code file added when processing the code processing task, which needs to be obtained by adding a code file. The original code file refers to a code file that already existed before processing the code processing task, for example, it may be any code file in a local storage space.

It may be understood that different code processing tasks may correspond to different target code files.

At S103, the first dialog text is input into a large model, and the large model outputs a code processing result of the target code file and a second dialog text corresponding to the first dialog text.

It needs to be noted that the large model may be implemented using any large model in the related art, which is not excessively limited here. For example, it may be a Transformer model. It should be noted that the Transformer model is a neural network model based on a self-attention mechanism. For example, the large model may be an LLM. For example, the large model is deployed on a server.

It needs to be noted that the code processing result is not excessively limited.

For example, taking the code adjustment task as an example, the code processing result includes a code adjustment result, such as an added code, a deleted code, a code before modification, a code after modification, a position adjustment of a code in the code file, etc.

For example, taking the code testing task as an example, the code processing result includes a code testing result, such as whether the code file passed the test, a testing metric of the code file, a code testing log, etc.

For example, taking the code verification task as an example, the code processing result includes a code verification result, such as whether verification of the code file is passed, a verification metric of the code file, whether the code file has vulnerabilities, a number of vulnerabilities in the code file, a risk level of vulnerabilities, a code with vulnerabilities, a position of the code with vulnerabilities in the code file, a code verification log, etc.

For example, taking the code repair task as an example, the code processing result includes a code repair result, such as a code repair strategy, a code repair log, etc.

For example, the code processing result includes an initial processing result and a final processing result. The initial processing result refers to an initial result of the code processing task, and the final processing result refers to a final result of the code processing task. The initial processing result may be different from the final processing result. For example, taking a code generation task as an example, the initial processing result may include an initial code, and the final processing result may include a final code.

In an implementation, the method further includes determining a task type of the code processing task via the large model based on the first dialog text, determining a target tool from a plurality of candidate tools via the large model based on the task type, and generating the code processing result via the target tool by invoking the target tool by the large model. It should be noted that the plurality of candidate tools include the target tool, and there is at least one target tool. The candidate tool and the target tool are not excessively limited, for example, they may include a code generation tool, a code testing tool, a code verification tool, a code repair tool, etc.

In an implementation, the method further includes generating the initial processing result via the large model based on the first dialog text, and obtaining the final processing result by adjusting the initial processing result via the large model.

For example, the method further includes, in response to the code processing task including the code generation task, invoking the code generation tool by the large model, generating the initial code by the code generation tool, verifying the initial code by invoking the code verification tool via the large model, invoking the code repair tool via the large model in response to a verification result of the initial code indicating that verification of the initial code is failed, and obtaining the final code by repairing the initial code via the code repair tool.

Or, the method further includes, in response to the verification result of the initial code indicating that verification of the initial code is failed, re-invoking the code generation tool via the large model, generating a candidate code via the code generation tool until verification of the candidate code is passed, and determining the candidate code that passed the verification as the final code.

It needs to be noted that a second dialog text is a text composed of natural language, and the second dialog text is not excessively limited, for example, it may be composed of at least one language, such as Chinese, English, and so on.

For example, the second dialog text may include “Certainly, I can help you add a log function and better exception handling in xx1. We will use xx2 to add a log and add xx3 around a key operation to handle a possible exception. The following is a modification to xx1.” “xx2” is used to represent the code generation tool, and “xx3” is used to represent a code block.

For example, the second dialog text may include “The above are all vulnerabilities scanned and repaired for you. Finally, let's summarize. In this task, a files in total are detected, c vulnerabilities in b files are found, and we attempted automatic repair on d vulnerabilities among c vulnerabilities. Next, you can view summarized information in a chart below, use a repair result I provided by clicking an accept button, or you can try manual repair with reference to vulnerability details and repair suggestions.”

In an implementation, the method further includes obtaining task information of the code processing task via the large model based on the first dialog text, adding the code processing result and/or a task progress to the task information via the large model, and generating the second dialog text via the large model based on the task information.

In some examples, the method further includes adding the second dialog text to the task information.

It needs to be noted that the task information is not excessively limited, for example, it may include a task type, file information (such as a file name) of the target code file corresponding to the code processing task, the code processing result, the task progress (such as, not processed, being processed, processed), a target dialog text, etc.

In some examples, generating the second dialog text via the large model based on the task information includes determining a target dialog template from a plurality of candidate dialog templates via the large model based on the task type of the code processing task, and generating the second dialog text via the large model based on the target dialog template and the task information.

At S104, the code processing result and a target dialog text are displayed on an interaction interface, in which the target dialog text includes at least one of the first dialog text or the second dialog text.

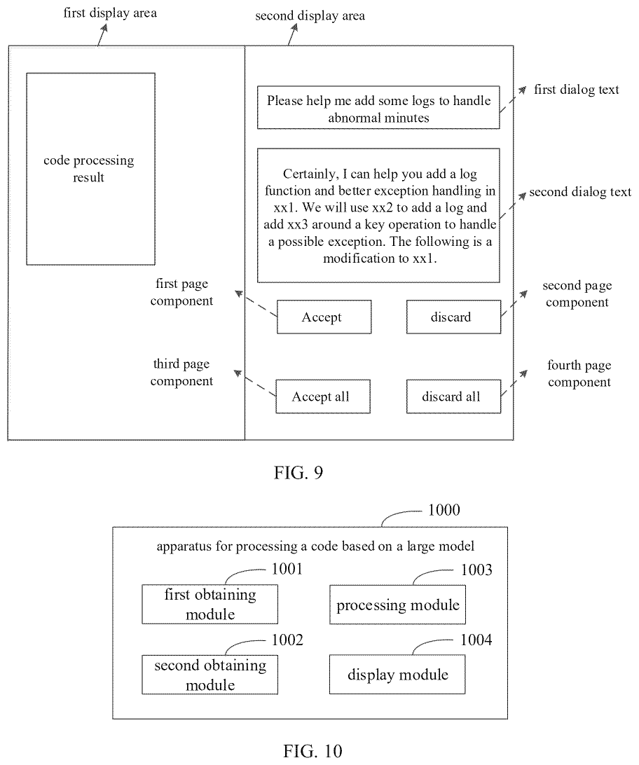

It needs to be noted that a display area of the code processing result on the interaction interface may be different from a display area of the target dialog text on the interaction interface. For example, the interaction interface includes a first display area and a second display area. The code processing result may be displayed in the first display area, and the target dialog text may be displayed in the second display area. For example, as shown in FIG. 9, the first display area is located in a left area of the interaction interface, and the second display area is located in a right area (such as a sidebar) of the interaction interface.

For example, taking the code adjustment task as an example, the interaction interface includes a coding area and a dialog area. The code adjustment result may be displayed in the coding area, and the target dialog text may be displayed in the dialog area.

For example, a display style of the code adjustment result is a Diff (Differences) style, which makes it easier for the user to intuitively understand a code adjustment situation.

For example, the code processing result and/or the target dialog text may be displayed on the interaction interface according to a streaming display mode. It should be noted that the streaming display mode refers to display content multiple times and gradually display, for example, line by line. Compared to displaying the complete content to the user at once, the streaming display mode may respond to code processing needs of the user faster and optimize user experience in a code processing scenario.

In the method for processing a code based on a large model provided in the present disclosure, the first dialog text for describing the code processing task is obtained; the at least one of the newly added code file or the original code file is determined as the target code file corresponding to the code processing task; the first dialog text is input into the large model, and the large model outputs the code processing result of the target code file and the second dialog text corresponding to the first dialog text; and the code processing result and the target dialog text are displayed on the interaction interface, in which the target dialog text includes the at least one of the first dialog text or the second dialog text. Thus, the newly added code file and/or the original code file may be determined as the code file to be processed, which may achieve automatic determination of the code file to be processed. The user only needs to perform a dialog operation, without manually adding a code file or specifying (e.g., selecting, opening) the code file to be processed on the client, which simplifies an operation of the user. In addition, the code processing result of the target code file and the second dialog text may be obtained via the large model based on the first dialog text, which may achieve automatic processing of the code processing task and improves a code processing efficiency. The code processing result and the target dialog text may be displayed on the interaction interface, which makes it easier for the user to intuitively understand a processing situation of the code processing task and optimizes user experience in a code processing scenario.

In the above embodiment, determining the newly added code file or the original code file as the target code file corresponding to the code processing task in the step S102 may be further understood in combination with FIG. 2. FIG. 2 is a flowchart of a method for processing a code based on a large model according to another embodiment of the present disclosure. As shown in FIG. 2, the method includes steps at S201 to S205.

At S201, a first dialog text for describing a code processing task is obtained.

Reference to the related content of the step S201 may be made to the above embodiments, which will not be repeated here.

At S202, in response to the code processing task meeting a preset condition, a new code file is added and the newly added code file is determined as the target code file.

It needs to be noted that the preset condition is not excessively limited.

In an implementation, the method further includes, in response to the task type of the code processing task being a preset type, determining that the code processing task meets the preset condition. Thus, in the case that the task type of the code processing task is the preset type, the code file may be added, and the newly added code file may be used as the code file to be processed.

For example, the method further includes, in response to the code processing task including at least one of generating a test code or adding a code template, determining that the code processing task meets the preset condition. Thus, in the case that the code processing task includes generating the test code and/or adding the code template, the code file may be added, and the newly added code file may be used as the code file to be processed.

At S203, in response to the code processing task not meeting the preset condition, the target code file is determined from a plurality of original code files.

In an implementation, determining the target code file from the plurality of original code files includes determining a search parameter of the target code file based on the first dialog text; and determining the target code file from the plurality of original code files based on the search parameter. Thus, the search parameter may be determined in consideration of the first dialog text, so that the target code file is determined from the plurality of original code files.

It needs to be noted that the search parameter is not excessively limited, for example, it may include an identifier of the target code file, a storage path, a file type, etc.

In some examples, determining the search parameter of the target code file based on the first dialog text includes extracting the search parameter from the first dialog text.

In some examples, determining the search parameter of the target code file based on the first dialog text includes obtaining the search parameter by performing a semantic analysis on the first dialog text via the large model.

At S204, the first dialog text is input into a large model, and the large model outputs a code processing result of the target code file and a second dialog text corresponding to the first dialog text.

At S205, the code processing result and a target dialog text are displayed on an interaction interface, in which the target dialog text includes at least one of the first dialog text or the second dialog text.

Reference to the related content of the steps S204 to S205 may be made to the above embodiments, which will not be repeated here.

In the method for processing a code based on a large model provided in the present disclosure, in response to the code processing task meeting the preset condition, the new code file is added and the newly added code file is determined as the target code file; in response to the code processing task not meeting the preset condition, the target code file is determined from the plurality of original code files. Thus, whether the code processing task meets the preset condition may be identified to determine whether a new code file needs to be added. For example, when the code processing task meets the preset condition, the new code file is added and is determined as the code file to be processed; and when the code processing task does not meet the preset condition, the code file to be processed is determined from the plurality of original code files.

On the basis of any one of the above embodiments, the method further includes, in response to the target code file not being displayed on the interaction interface, displaying the target code file on the interaction interface; or in response to the target code file being displayed on the interaction interface, continuing to display the target code file on the interaction interface. Thus, an automatic display of the code file to be processed on the interaction interface may be achieved, without manually opening by the user the code file to be processed on the client, which simplifies an operation of the user.

On the basis of any one of the above embodiments, displaying the code processing result on the interaction interface includes, in response to the code processing result including a code adjustment result, display the code adjustment result within a display area of the target code file on the interaction interface. Thus, the code adjustment result may be displayed within the display area of the code file to be processed on the interaction interface, which makes it easier for the user to intuitively understand a code adjustment situation.

For example, in response to a code processing result of a target code file A including a generated code block 1, the code block 1 may be displayed in green within a display area of the target code file A on the interaction interface.

For example, in response to a code processing result of a target code file B including a deleted code block 2, the code block 2 may be displayed in red within a display area of the target code file B on the interaction interface.

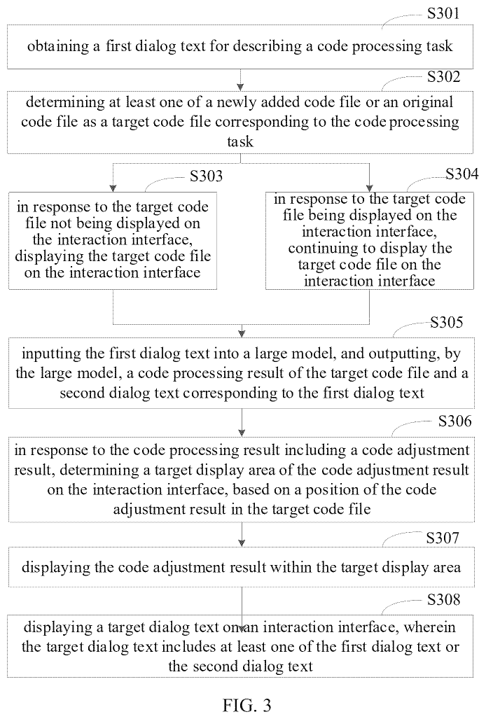

In the above embodiments, displaying the code processing result on the interaction interface in the step S104 may be further understood in combination with FIG. 3. FIG. 3 is a flowchart of a method for processing a code based on a large model according to another embodiment of the present disclosure. As shown in FIG. 3, the method includes steps at S301 to S308.

At S301, a first dialog text for describing a code processing task is obtained.

At S302, at least one of a newly added code file or an original code file is determined as a target code file corresponding to the code processing task.

At S303, in response to the target code file not being displayed on the interaction interface, the target code file is displayed on the interaction interface.

At S304, in response to the target code file being displayed on the interaction interface, it is continued to display the target code file on the interaction interface.

At S305, the first dialog text is input into a large model, and the large model outputs a code processing result of the target code file and a second dialog text corresponding to the first dialog text.

Reference to the related content of the steps S301 to S305 may be made to the above embodiments, which will not be repeated here.

At S306, in response to the code processing result including a code adjustment result, a target display area of the code adjustment result on the interaction interface is determined based on a position of the code adjustment result in the target code file.

At S307, the code adjustment result is displayed within the target display area.

It needs to be noted that the target display area of the code adjustment result on the interaction interface may be located within the display area of the target code file on the interaction interface, or may be located outside the display area of the target code file on the interaction interface, which is not excessively limited here.

In an implementation, determining the target display area of the code adjustment result on the interaction interface based on the position of the code adjustment result in the target code file includes obtaining a mapping relationship between a position of a candidate code segment in the target code file and a candidate display area of the candidate code segment on the interaction interface, and obtaining a candidate display area that has a mapping relationship with the position of the code adjustment result in the target code file as the target display area.

In an implementation, determining the target display area of the code adjustment result on the interaction interface based on the position of the code adjustment result in the target code file includes, obtaining, based on the position of the code adjustment result in the target code file, a candidate code segment adjacent to the code adjustment result in the target code file as a target code segment, and using a surrounding area of a display area of the target code segment on the interaction interface as the target display area. It should be noted that the surrounding area is not excessively limited, for example, it may include a left area, a right area, etc.

It needs to be noted that the position of the code adjustment result in the target code file is not excessively limited, for example, it may include a code line number.

At S308, a target dialog text is displayed on an interaction interface, in which the target dialog text includes at least one of the first dialog text or the second dialog text.

Reference to the related content of the step S308 may be made to the above embodiments, which will not be repeated here.

In the method for processing a code based on a large model provided in the present disclosure, in response to the code processing result including a code adjustment result, a target display area of the code adjustment result on the interaction interface is determined based on a position of the code adjustment result in the target code file; and the code adjustment result is displayed within the target display area. Thus, the target display area of the code adjustment result may be determined in consideration of the position of the code adjustment result in the code file to be processed, so as to display the code adjustment result, which improves the flexibility of displaying the code adjustment result.

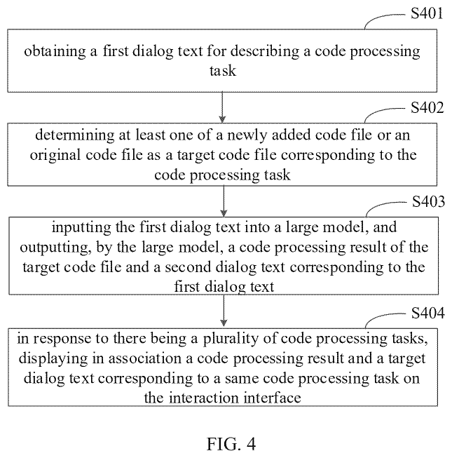

In the above embodiment, displaying the code processing result and the target dialog text on the interaction interface in the step S104 may be further understood in combination with FIG. 4. FIG. 4 is a flowchart of a method for processing a code based on a large model according to another embodiment of the present disclosure. As shown in FIG. 4, the method includes steps at S401 to S404.

At S401, a first dialog text for describing a code processing task is obtained.

At S402, at least one of a newly added code file or an original code file is determined as a target code file corresponding to the code processing task.

At S403, the first dialog text is input into a large model, and the large model outputs a code processing result of the target code file and a second dialog text corresponding to the first dialog text.

Reference to the related content of the steps S401 to S403 may be made to the above embodiments, which will not be repeated here.

At S404, in response to there being a plurality of code processing tasks, a code processing result and a target dialog text corresponding to a same code processing task on the interaction interface are displayed in association.

It needs to be noted that the code processing result corresponding to the code processing task refers to a code processing result of the target code file corresponding to the code processing task.

For example, the code processing tasks include code processing tasks 1 to 3. Taking the code processing task 1 as an example, a code processing result corresponding to the code processing task 1 and a target dialog text corresponding to the code processing task 1 may be displayed in association on the interaction interface. Taking the code processing task 2 as an example, a code processing result corresponding to the code processing task 2 and a target dialog text corresponding to the code processing task 2 may be displayed in association on the interaction interface. Taking the code processing task 3 as an example, a code processing result corresponding to the code processing task 3 and a target dialog text corresponding to the code processing task 3 may be displayed in association on the interaction interface.

It needs to be noted that a specific method for displaying in association the code processing result and the target dialog text corresponding to the same code processing task is not excessively limited.

For example, displaying in association the code processing result and the target dialog text corresponding to the same code processing task includes, in response to detecting a first operation for a code processing result corresponding to the i-th code processing task, displaying a target dialog text corresponding to the i-th code processing task on the interaction interface. It should be noted that the first operation is not excessively limited, for example, it may include a mouse hover operation, a click operation, etc.

For example, displaying in association the code processing result and the target dialog text corresponding to the same code processing task includes, in response to detecting a first operation for a target dialog text corresponding to the i-th code processing task, displaying a code processing result corresponding to the i-th code processing task on the interaction interface.

For example, displaying in association the code processing result and the target dialog text corresponding to the same code processing task includes establishing a hyperlink between the code processing result and the target dialog text corresponding to the same code processing task.

For example, displaying in association the code processing result and the target dialog text corresponding to the same code processing task includes, in an area surrounding a display area of a code processing result corresponding to the i-th code processing task on the interaction interface, displaying a target dialog text corresponding to the i-th code processing task.

In the method for processing a code based on a large model provided in the present disclosure, in response to there being the plurality of code processing tasks, the code processing result and the target dialog text corresponding to the same code processing task on the interaction interface are displayed in association. Thus, when there are a plurality of code processing tasks, the code processing result and the target dialog text corresponding to the same code processing task may be displayed in association on the interaction interface, which makes it easier for the user to distinguish a code processing result and its associated target dialog text, corresponding to each of the plurality of code processing tasks, simplifies an operation of the user, and optimizes user experience in a code processing scenario.

On the basis of any one of the above embodiments, the method further includes, in response to there being a plurality of code processing tasks, generating a task list based on task information of each of the plurality of code processing tasks; and displaying the task list on the interaction interface. Thus, when there are a plurality of code processing tasks, a task list may be generated and displayed considering the task information of each of the code processing tasks, which makes it easier for the user to intuitively understand the task information of each of the code processing tasks, and optimizes user experience in a code processing scenario.

For example, an i-th item of the task list may be generated based on task information (such as the first dialog text and a task progress) of the i-th code processing task, in which the i-th item is used to represent the i-th code processing task.

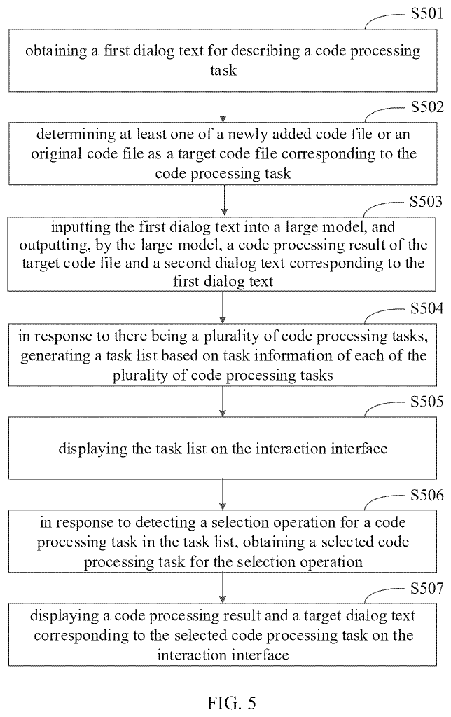

In the above embodiment, displaying the code processing result and the target dialog text on the interaction interface in the step S104 may be further understood in combination with FIG. 5. FIG. 5 is a flowchart of a method for processing a code based on a large model according to another embodiment of the present disclosure. As shown in FIG. 5, the method includes steps at S501 to S507.

At S501, a first dialog text for describing a code processing task is obtained.

At S502, at least one of a newly added code file or an original code file is determined as a target code file corresponding to the code processing task.

At S503, the first dialog text is input into a large model, and the large model outputs a code processing result of the target code file and a second dialog text corresponding to the first dialog text.

At S504, in response to there being a plurality of code processing tasks, a task list is generated based on task information of each of the plurality of code processing tasks.

At S505, the task list is displayed on the interaction interface.

Reference to the related content of the steps S501 to S505 may be made to the above embodiments, which will not be repeated here.

At S506, in response to detecting a selection operation for a code processing task in the task list, a selected code processing task for the selection operation is obtained.

At S507, a code processing result and a target dialog text corresponding to the selected code processing task are displayed on the interaction interface.

It needs to be noted that the selection operation is not excessively limited, for example, it may include a click operation, a mouse hover operation, etc.

For example, an i-th item of the task list may be generated based on task information of the i-th code processing task, in which the i-th item is used to represent the i-th code processing task. In response to detecting a selection operation for the i-th item in the task list, the i-th code processing task may be determined as the selected code processing task for the selection operation.

For example, the task list may be displayed on the interaction interface. The task list includes 10 list items (or items). In response to detecting a selection operation for the third item in the task list, the third code processing task is determined as the selected code processing task for the selection operation, and a code processing result and a target dialog text corresponding to the third code processing task are displayed on the interaction interface.

In the method for processing a code based on a large model provided in the present disclosure, in response to detecting the selection operation for the code processing task in the task list, the selected code processing task for the selection operation is obtained; and the code processing result and the target dialog text corresponding to the selected code processing task are displayed on the interaction interface. Thus, the selection operation of the user for a certain code processing task in the task list may trigger displaying the corresponding code processing result and target dialog text, that is, displaying the code processing result and the target dialog text corresponding to the code processing task selected by the user on the interaction interface, which may achieve a personalized display of the code processing result and the target dialog text, and optimizes user experience in a code processing scenario.

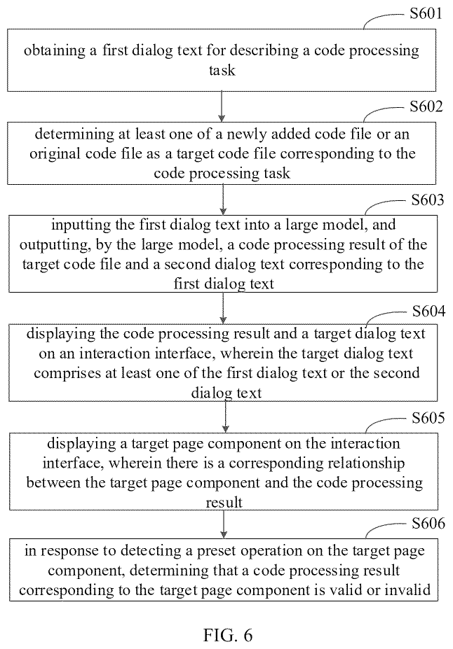

FIG. 6 is a flowchart of a method for processing a code based on a large model according to another embodiment of the present disclosure. As shown in FIG. 6, the method includes steps at S601 to S606.

At S601, a first dialog text for describing a code processing task is obtained.

At S602, at least one of a newly added code file or an original code file is determined as a target code file corresponding to the code processing task.

At S603, the first dialog text is input into a large model, and the large model outputs a code processing result of the target code file and a second dialog text corresponding to the first dialog text.

At S604, the code processing result and a target dialog text are displayed on an interaction interface, in which the target dialog text includes at least one of the first dialog text or the second dialog text.

Reference to the related content of the steps S601 to S604 may be made to the above embodiments, which will not be repeated here.

At S605, a target page component is displayed on the interaction interface, in which there is a corresponding relationship between the target page component and the code processing result.

At S606, in response to detecting a preset operation on the target page component, it is determined that a code processing result corresponding to the target page component is valid or invalid.

It needs to be noted that the preset operation is not excessively limited, for example, it may include a click operation.

In an implementation, the target page component includes a first page component. There is a one-to-one correspondence between the first page component and the code processing result. In response to detecting the preset operation for the target page component, determining that the code processing result corresponding to the target page component is valid or invalid includes, in response to detecting a preset operation for the first page component, determining that a code processing result corresponding to the first page component is valid.

For example, the first page component includes icons such as “accept”, “agree”, etc. As shown in FIG. 9, the first page component is an “accept” icon.

In an implementation, the target page component includes a second page component. There is a one-to-one correspondence between the second page component and the code processing result. In response to detecting the preset operation for the target page component, determining that the code processing result corresponding to the target page component is valid or invalid includes, in response to detecting a preset operation for the second page component, determining that a code processing result corresponding to the second page component is invalid.

For example, the second page component includes icons such as “discard”, “reject”, etc. As shown in FIG. 9, the second page component is a “discard” icon.

In an implementation, the target page component includes a third page component. In response to detecting the preset operation for the target page component, determining that the code processing result corresponding to the target page component is valid or invalid includes, in response to detecting a preset operation for the third page component, determining that each code processing result is valid. It may be understood that there is a corresponding relationship between the third page component and the each code processing result.

For example, the third page component includes icons such as “accept all”, “agree to all”, etc. As shown in FIG. 9, the third page component is an “accept all” icon.

In an implementation, the target page component includes a fourth page component. In response to detecting the preset operation for the target page component, determining that the code processing result corresponding to the target page component is valid or invalid includes, in response to detecting a preset operation for the fourth page component, determining that each code processing result is invalid. It may be understood that there is a corresponding relationship between the fourth page component and the each code processing result.

For example, the fourth page component includes icons such as “discard all”, “reject all”, etc. As shown in FIG. 9, the fourth page component is a “discard all” icon.

In an implementation, after determining that the code processing result is valid, the method further includes, in response to the target code file being the newly added code file, saving the target code file; in response to the code processing result including a code adjustment result, updating the target code file based on the code adjustment result; or in response to the code processing result including a code repair strategy, repairing the target code file according to the code repair strategy. Thus, after determining that the code processing result is valid, the newly added code file may be saved, and/or the code file to be processed may be updated in consideration of the code adjustment result, so as to update the code file, and/or the code file to be processed may be repaired in consideration of the code repair strategy so as to repair the code file.

In some examples, updating the target code file based on the code adjustment result includes, in response to the code adjustment result including a newly added code, storing the newly added code into the target code file; in response to the code adjustment result including a deleted code, deleting the deleted code from the target code file; in response to the code adjustment result including a code before modification and a code after modification, replacing the code before modification in the target code file with the code after modification; or in response to the code adjustment result indicating to delete the target code file, deleting the target code file.

In an implementation, after determining that the code processing result is invalid, the method further includes, in response to the target code file being the newly added code file, deleting the target code file; or in response to the target code file being the original code file, maintaining the target code file unchanged. Thus, after determining that the code processing result is invalid, the newly added code file may be deleted, and/or the original code file may be kept unchanged.

In the method for processing a code based on a large model provided in the present disclosure, the target page component is displayed on the interaction interface, in which there is the corresponding relationship between the target page component and the code processing result; and in response to detecting the preset operation on the target page component, determining that the code processing result corresponding to the target page component is valid or invalid. Thus, based on the preset operation of the user for the target page component, it may be determined whether the code processing result is valid or invalid, that is, whether the code processing result is valid may be determined in consideration of the user feedback, which may achieve personalized settings for whether the code processing result is valid, and optimizes user experience in a code processing scenario.

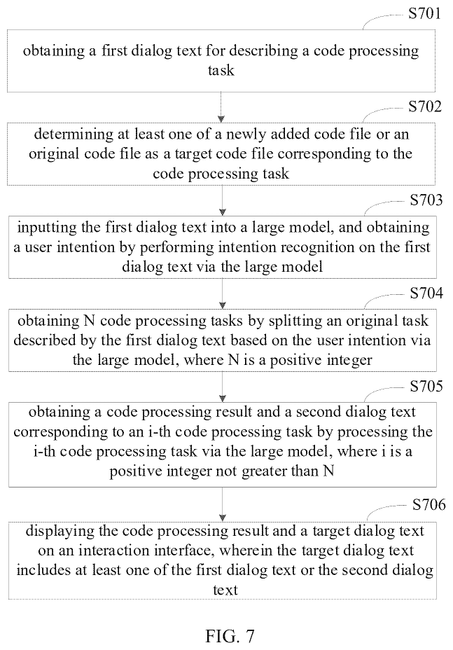

FIG. 7 is a flowchart of a method for processing a code based on a large model according to another embodiment of the present disclosure. As shown in FIG. 7, the method includes steps at S701 to S706.

At S701, a first dialog text for describing a code processing task is obtained.

At S702, at least one of a newly added code file or an original code file is determined as a target code file corresponding to the code processing task.

Reference to the related content of the steps S701 to S702 may be made to the above embodiments, which will not be repeated here.

At S703, the first dialog text is input into a large model, and a user intention is obtained by performing intention recognition on the first dialog text via the large model.

It needs to be noted that any method for recognizing an intention in the related art may be used to perform the intention recognition on the first dialog text via the large model, which is not excessively limited here.

At S704, N code processing tasks are obtained by splitting an original task described by the first dialog text based on the user intention via the large model, where N is a positive integer.

In an implementation, obtaining N code processing tasks by splitting an original task described by the first dialog text based on the user intention via the large model includes: splitting the original task into N code processing tasks of a single-task category based on the user intention via the large model.

For example, the first dialog text is “Please help me write a unit test code and perform unit testing on xx1”. The intention recognition on the first dialog text is performed via the large model so as to obtain the user intention (which is generating unit test code and performing unit testing on xx1). Based on the user intention, the original task described by the above first dialog text is split via the large model to obtain the code processing task 1 and the code processing task 2, in which the code processing task 1 is a code adjustment task of generating the unit test code, and the code processing task 2 is a code testing task of performing the unit testing on xx1.

At S705, a code processing result and a second dialog text corresponding to an i-th code processing task are obtained by processing the i-th code processing task via the large model, where i is a positive integer not greater than N.

In an implementation, a plurality of code processing tasks via the large model are processed in parallel, that is, the large model may generate the code processing result corresponding to each of the code processing tasks in parallel, and a second dialog text for each of the code processing tasks in parallel.

It needs to be noted that reference to the related content of the step S705 may be made to the relevant content of the step S103, which will not be repeated here.

At S706, the code processing result and a target dialog text are displayed on an interaction interface, in which the target dialog text includes at least one of the first dialog text or the second dialog text.

Reference to the related content of the step S706 may be made to the above embodiments, which will not be repeated here.

In the method for processing a code based on a large model provided in the present disclosure, the user intention is obtained by performing the intention recognition on the first dialog text via the large model; the N code processing tasks are obtained by splitting the original task described by the first dialog text based on the user intention via the large model, where N is a positive integer; and the code processing result and the second dialog text corresponding to the i-th code processing task are obtained by processing the i-th code processing task via the large model, where i is the positive integer not greater than N. Thus, the intention recognition may be performed on the first dialog text via the large model to split the task and obtain a plurality of code processing tasks, and the plurality of code processing tasks may be processed via the large model, which is suitable for a processing scenario involving complex code processing tasks. In this way, the user only needs to perform a dialog operation without splitting the task themselves, which simplifies a user operation and optimizes user experience in a code processing scenario.

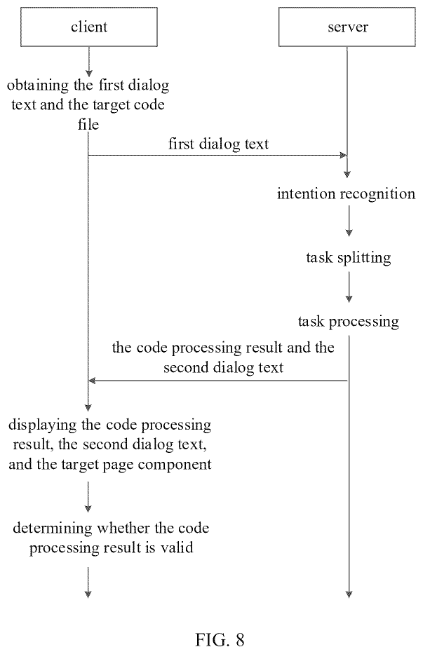

On the basis of any one of the above embodiments, as shown in FIG. 8, the client may obtain the first dialog text and the target code file, and send the first dialog text to a server.

The server may input the first dialog text into the large model, obtain the user intention by performing the intention recognition on the first dialog text via the large model, obtain the N code processing tasks by splitting the original task described by the first dialog text based on the user intention via the large model, invoke the target tool via the large model to process the i-th code processing task and thus obtain the code processing result and the second dialog text corresponding to the i-th code processing task, and send the code processing result and the second dialog text output by the large model to the client.

The client may display the code processing result, the second dialog text, and the target page component on the interaction interface, and in response to detecting a preset operation for the target page component, it is determined whether the code processing result corresponding to the target page component is valid.

In the technical solution of the present disclosure, the processing including collection, storage, use, shaping, transmission, provision and disclosure of personal information from the user is in compliance with provisions of relevant laws and regulations, and do not violate public order and moral.

According to the embodiments of the present disclosure, the present disclosure also provides an apparatus for processing a code based on a large model, configured to implement the above method for processing a code based on a large model.

FIG. 10 is a block diagram of an apparatus for processing a code based on a large model according to an embodiment of the present disclosure.

As shown in FIG. 10, the apparatus 1000 for processing a code based on a large model includes: a first obtaining module 1001, a second obtaining module 1002, a processing module 1003, and a display module 1004.

The first obtaining module 1001 is configured to obtain a first dialog text for describing a code processing task; the second obtaining module 1002 is configured to determine at least one of a newly added code file or an original code file as a target code file corresponding to the code processing task; the processing module 1003 is configured to input the first dialog text into a large model, and output, via the large model, a code processing result of the target code file and a second dialog text corresponding to the first dialog text; and the display module 1004 is configured to display the code processing result and a target dialog text on an interaction interface, in which the target dialog text includes at least one of the first dialog text or the second dialog text.

In an embodiment of the present disclosure, the display module 1004 is further configured to: in response to the target code file not being displayed on the interaction interface, display the target code file on the interaction interface; or in response to the target code file being displayed on the interaction interface, continue to display the target code file on the interaction interface.

In an embodiment of the present disclosure, the display module 1004 is further configured to: in response to the code processing result including a code adjustment result, display the code adjustment result within a display area of the target code file on the interaction interface.

In an embodiment of the present disclosure, the display module 1004 is further configured to: in response to the code processing result including a code adjustment result, determine a target display area of the code adjustment result on the interaction interface, based on a position of the code adjustment result in the target code file; and display the code adjustment result within the target display area.

In an embodiment of the present disclosure, the display module 1004 is further configured to: in response to there being a plurality of code processing tasks, display in association a code processing result and a target dialog text corresponding to a same code processing task on the interaction interface.

In an embodiment of the present disclosure, the display module 1004 is further configured to: in response to there being a plurality of code processing tasks, generate a task list based on task information of each of the plurality of code processing tasks; and display the task list on the interaction interface.

In an embodiment of the present disclosure, the display module 1004 is further configured to: in response to detecting a selection operation for a code processing task in the task list, obtain a selected code processing task for the selection operation; and display a code processing result and a target dialog text corresponding to the selected code processing task on the interaction interface.

In an embodiment of the present disclosure, the display module 1004 is further configured to: display a target page component on the interaction interface, in which there is a corresponding relationship between the target page component and the code processing result; and in response to detecting a preset operation on the target page component, determine that a code processing result corresponding to the target page component is valid or invalid.

In an embodiment of the present disclosure, after determining that the code processing result is valid, the processing module 1003 is further configured to: in response to the target code file being the newly added code file, save the target code file; in response to the code processing result including a code adjustment result, update the target code file based on the code adjustment result; or in response to the code processing result including a code repair strategy, repair the target code file according to the code repair strategy.

In an embodiment of the present disclosure, after determining that the code processing result is invalid, the processing module 1003 is further configured to: in response to the target code file being the newly added code file, delete the target code file; or in response to the target code file being the original code file, maintain the target code file unchanged.

In an embodiment of the present disclosure, the second obtaining module 1002 is further configured to: in response to the code processing task meeting a preset condition, add a new code file and take a newly added code file as the target code file; or in response to the code processing task not meeting the preset condition, determine the target code file from a plurality of original code files.

In an embodiment of the present disclosure, the second obtaining module 1002 is further configured to: in response to the code processing task including at least one of generating a test code or adding a code template, determine that the code processing task meets the preset condition.

In an embodiment of the present disclosure, the second obtaining module 1002 is further configured to: determine a search parameter of the target code file based on the first dialog text; and determine the target code file from the plurality of original code files based on the search parameter.

In an embodiment of the present disclosure, the processing module 1003 is further configured to: obtain a user intention by performing intention recognition on the first dialog text via the large model; obtain N code processing tasks by splitting an original task described by the first dialog text based on the user intention via the large model, where N is a positive integer; and obtain a code processing result and a second dialog text corresponding to an i-th code processing task by processing the i-th code processing task via the large model, where i is a positive integer not greater than N.

In the apparatus for processing a code based on a large model provided in the present disclosure, the first dialog text for describing the code processing task is obtained; the at least one of the newly added code file or the original code file is determined as the target code file corresponding to the code processing task; the first dialog text is input into the large model, and the large model outputs the code processing result of the target code file and the second dialog text corresponding to the first dialog text; and the code processing result and the target dialog text are displayed on the interaction interface, in which the target dialog text includes the at least one of the first dialog text or the second dialog text. Thus, the newly added code file and/or the original code file may be determined as the code file to be processed, which may achieve automatic determination of the code file to be processed. The user only needs to perform a dialog operation, without manually adding a code file or specifying (e.g., selecting, opening) the code file to be processed on the client, which simplifies an operation of the user. In addition, the code processing result of the target code file and the second dialog text may be obtained via the large model based on the first dialog text, which may achieve automatic processing of the code processing task and improves a code processing efficiency. The code processing result and the target dialog text may be displayed on the interaction interface, which makes it easier for the user to intuitively understand a processing situation of the code processing task and optimizes user experience in a code processing scenario.

According to the embodiments of the present disclosure, the present disclosure also provides an electronic device, a readable storage medium, and a computer program product.

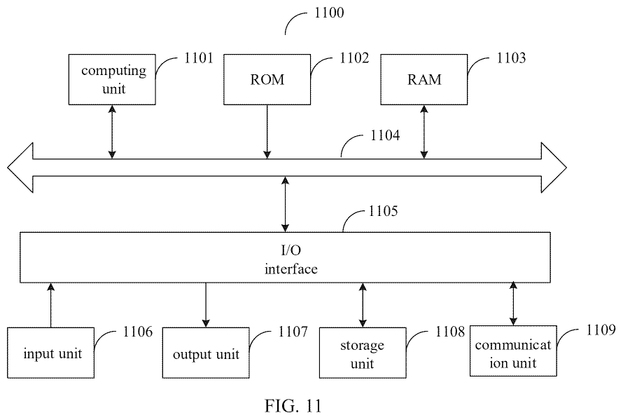

FIG. 11 is a block diagram of an electronic device 1100 according to an embodiment of the present disclosure. The electronic device aims to represent various forms of digital computers, such as a laptop computer, a desktop computer, a workstation, a personal digital assistant, a server, a blade server, a mainframe computer and other suitable computer. The electronic device may also represent various forms of mobile devices, such as personal digital processing, a cellular phone, a smart phone, a wearable device and other similar computing device. The components, connections and relationships of the components, and functions of the components shown herein are merely examples, and are not intended to limit the implementation of the disclosure described and/or claimed herein.

As shown in FIG. 11, the device 1100 includes a computing unit 1101. The computing unit 1101 may perform various appropriate actions and processes based on a computer program stored in a read only memory (ROM) 1102 or loaded from a storage unit 1108 into a random access memory (RAM) 1103. In the RAM 1103, various programs and data required for the operation of the device 1100 may also be stored. The computing unit 1101, the ROM 1102, and the RAM 1103 are connected to each other via a bus 1104. An input/output (I/O) interface 1105 is also connected to the bus 1104.

A plurality of components in the device 1100 are connected to the I/O interface 1105. The plurality of components include an input unit 1106, such as a keyboard, and a mouse; an output unit 1107, such as various types of displays and speakers; a storage unit 1108, such as a magnetic disk, and an optical disk; and a communication unit 1109, such as a network card, a modem, and a wireless communication transceiver. The communication unit 1109 allows the device 1100 to exchange information/data with other devices via a computer network such as the Internet and/or various telecommunication networks.

The computing unit 1101 may be various general-purpose and/or special-purpose processing components with processing and computing capabilities. Some examples of the computing unit 1101 include, but are not limited to, a central processing unit (CPU), a graphics processing unit (GPU), various dedicated AI computing chips, various computing units running machine learning model algorithms, a digital signal processor (DSP), and any suitable processor, controller, microcontroller, etc. The computing unit 1101 performs various methods and processes described above, such as the method for processing a code based on a large model. For example, in some embodiments, the method for processing a code based on a large model may be implemented as a computer software program tangibly embodied in a machine-readable medium, such as the storage unit 1108. In some embodiments, part or all of the computer program may be loaded and/or installed on the device 1100 via the ROM 1102 and/or the communication unit 1109. When the computer program is loaded into the RAM 1103 and executed by the computing unit 1101, one or more steps of the method for processing a code based on a large model described above may be executed. Optionally, in other embodiments, the computing unit 1101 may be configured to implement the method for processing a code based on a large model by any other suitable means (for example, by means of firmware).

Various implementations of the systems and techniques described above herein may be implemented in a digital electronic circuit system, an integrated circuit system, a field programmable gate array (FPGA), an application specific integrated circuit (ASIC), an application specific standard product (ASSP), a system on a chip (SOC), a load programmable logic device (CPLD), computer hardware, firmware, software, and/or a combination thereof. These various implementations may include: being implemented in one or more computer programs. The one or more computer programs may be executed and/or interpreted on a programmable system including at least one programmable processor. The programmable processor may be a special purpose or general purpose programmable processor and receive data and instructions from and transmit data and instructions to a storage system, at least one input device, and at least one output device.

The program codes for implementing the method of the disclosure may be written in any combination of one or more programming languages. These program codes may be provided to a processor or controller of a general purpose computer, a special purpose computer, or other programmable data processing apparatus, such that the program codes, when executed by the processor or controller, cause the functions/operations specified in the flowcharts and/or block diagrams to be implemented. The program codes may be executed completely on the machine, partially on the machine, partially on the machine as an independent software package and partially on a remote machine or completely on a remote machine or server.

In the context of the disclosure, a machine-readable medium may be a tangible medium, which may include or store a program for use by or in connection with an instruction execution system, an apparatus or a device. The machine-readable medium may be a machine-readable signal medium or a machine-readable storage medium. The machine-readable medium may include, but is not limited to, an electronic, magnetic, optical, electromagnetic, infrared, or semiconductor system, an apparatus, or a device, or any suitable combination of the above. More specific examples of the machine-readable storage medium may include one or more wire-based electrical connections, a portable computer disk, a hard disk, a RAM, a ROM, an erasable programmable read-only memory (EPROM or flash memory), an optical fiber, a portable compact disk read-only memory (CD-ROM), an optical storage device, a magnetic storage device, or any suitable combination of the above.

To provide interaction with a user account (or a user), the system and technologies described herein may be implemented on a computer. The computer has a display device (such as, a CRT (cathode ray tube) or a LCD (liquid crystal display) monitor) for displaying information to the user, a keyboard and a pointing device (such as, a mouse or a trackball), via which the user may provide the input to the computer. Other types of devices may also be configured to provide interaction with the user. For example, the feedback provided to the user may be any form of sensory feedback (such as, visual feedback, auditory feedback, or tactile feedback), and the input from the user may be received in any form (including acoustic input, voice input or tactile input).

The system and technologies described herein may be implemented in a computing system including a background component (such as, a data server), a computing system including a middleware component (such as, an application server), or a computing system including a front-end component (such as, a user computer having a graphical user interface or a web browser via which the user may interact with embodiments of the system and technologies described herein), or a computing system including any combination of the background component, the middleware component and the front-end component. Components of the system may be connected to each other via digital data communication in any form or medium (such as, a communication network). Examples of the communication network include a local area network (LAN), a wide area network (WAN), and the Internet.

The computer system may include a client and a server. The client and the server are generally remote from each other and generally interact via the communication network. A relationship between the client and the server is generated by computer programs operated on a corresponding computer and having a client-server relationship with each other. The server may be a cloud server, a server within a distributed system, or a server integrated with blockchain technology.

According to the embodiments of the present disclosure, the present disclosure also provides a computer program product, including a computer program that, when executed by a processor, implements steps of the method for processing a code based on a large model described in the above embodiments of the present disclosure.

It may be understood that various forms of processes shown above may be used to reorder, add or delete the steps. For example, the steps described in the disclosure may be performed in parallel, sequentially, or in a different order, as long as the desired result of the technical solution disclosed in the disclosure is achieved, which is not limited herein.

The above specific embodiments do not constitute a limitation on the protection scope of the disclosure. Those skilled in the art should understand that various modifications, combinations, sub-combinations and substitutions may be made according to design requirements and other factors. Any modification, equivalent replacement and improvement made within the principle of the disclosure shall be included in the protection scope of the disclosure.

1. A method for processing a code based on a large model in a human-machine interaction system, performed by an electronic device, the method comprising:
obtaining a first dialog text for describing a code processing task;
determining at least one of a newly added code file or an original code file as a target code file corresponding to the code processing task;
inputting the first dialog text into a large model, and outputting, via the large model, a code processing result of the target code file and a second dialog text corresponding to the first dialog text; and
displaying the code processing result and a target dialog text on an interaction interface, wherein the target dialog text comprises at least one of the first dialog text or the second dialog text.

2. The method of claim 1, further comprising:
in response to the target code file not being displayed on the interaction interface, displaying the target code file on the interaction interface; or
in response to the target code file being displayed on the interaction interface, continuing to display the target code file on the interaction interface.

3. The method of claim 2, wherein displaying the code processing result on the interaction interface comprises:
in response to the code processing result comprising a code adjustment result, displaying the code adjustment result within a display area of the target code file on the interaction interface.

4. The method of claim 1, wherein displaying the code processing result on the interaction interface comprises one of:
in response to the code processing result comprising a code adjustment result, determining a target display area of the code adjustment result on the interaction interface, based on a position of the code adjustment result in the target code file; and displaying the code adjustment result within the target display area; or
in response to there being a plurality of code processing tasks, displaying in association a code processing result and a target dialog text corresponding to a same code processing task on the interaction interface; or generating a task list based on task information of each of the plurality of code processing tasks and displaying the task list on the interaction interface.

5. The method of claim 4, wherein displaying the code processing result and the target dialog text on the interaction interface comprises:
in response to detecting a selection operation for a code processing task in the task list, obtaining a selected code processing task for the selection operation; and
displaying a code processing result and a target dialog text corresponding to the selected code processing task on the interaction interface.

6. The method of claim 1, further comprising:
displaying a target page component on the interaction interface, wherein there is a corresponding relationship between the target page component and the code processing result; and
in response to detecting a preset operation on the target page component, determining that a code processing result corresponding to the target page component is valid or invalid.

7. The method of claim 6, wherein
after determining that the code processing result is valid, the method further comprises one of:
in response to the target code file being the newly added code file, saving the target code file;
in response to the code processing result comprising a code adjustment result, updating the target code file based on the code adjustment result; or
in response to the code processing result comprising a code repair strategy, repairing the target code file according to the code repair strategy; or
after determining that the code processing result is invalid, the method further comprises one of:
in response to the target code file being the newly added code file, deleting the target code file; or in response to the target code file being the original code file, maintaining the target code file unchanged.

8. The method of claim 1, wherein determining at least one of the newly added code file or the original code file as the target code file corresponding to the code processing task comprises one of:
in response to the code processing task meeting a preset condition, adding a new code file and determining the newly added code file as the target code file; or
in response to the code processing task not meeting the preset condition, determining the target code file from a plurality of original code files.

9. The method of claim 8, further comprising:
in response to the code processing task comprising at least one of generating a test code or adding a code template, determining that the code processing task meets the preset condition; or
wherein determining the target code file from the plurality of original code files comprises:
determining a search parameter of the target code file based on the first dialog text; and
determining the target code file from the plurality of original code files based on the search parameter.

10. The method of claim 1, further comprising:
obtaining a user intention by performing intention recognition on the first dialog text via the large model;
obtaining N code processing tasks by splitting an original task described by the first dialog text based on the user intention via the large model, where N is a positive integer; and
obtaining a code processing result and a second dialog text corresponding to an i-th code processing task by processing the i-th code processing task via the large model, where i is a positive integer not greater than N.

11. An electronic device applied in a human-machine interaction system, comprising a processor and a memory storing instructions executable by the processor, wherein the processor is configured to:
obtain a first dialog text for describing a code processing task;
determine at least one of a newly added code file or an original code file as a target code file corresponding to the code processing task;
input the first dialog text into a large model, and output, via the large model, a code processing result of the target code file and a second dialog text corresponding to the first dialog text; and
display the code processing result and a target dialog text on an interaction interface, wherein the target dialog text comprises at least one of the first dialog text or the second dialog text.

12. The electronic device of claim 11, wherein the processor is further configured to:
in response to the target code file not being displayed on the interaction interface, display the target code file on the interaction interface; or
in response to the target code file being displayed on the interaction interface, continue to display the target code file on the interaction interface.

13. The electronic device of claim 12, wherein the processor is further configured to:
in response to the code processing result comprising a code adjustment result, display the code adjustment result within a display area of the target code file on the interaction interface.

14. The electronic device of claim 11, wherein the processor is further configured to:
in response to the code processing result comprising a code adjustment result, determine a target display area of the code adjustment result on the interaction interface, based on a position of the code adjustment result in the target code file; and display the code adjustment result within the target display area; or
in response to there being a plurality of code processing tasks, display in association a code processing result and a target dialog text corresponding to a same code processing task on the interaction interface, or generate a task list based on task information of each of the plurality of code processing tasks and display the task list on the interaction interface.

15. The electronic device of claim 14, wherein the processor is further configured to:
in response to detecting a selection operation for a code processing task in the task list, obtain a selected code processing task for the selection operation; and
display a code processing result and a target dialog text corresponding to the selected code processing task on the interaction interface.

16. The electronic device of claim 15, wherein the processor is further configured to:
display a target page component on the interaction interface, wherein there is a corresponding relationship between the target page component and the code processing result; and
in response to detecting a preset operation on the target page component, determine that a code processing result corresponding to the target page component is valid or invalid.

17. The electronic device of claim 16, wherein
after determining that the code processing result is valid, the processor is further configured to:
in response to the target code file being the newly added code file, save the target code file;
in response to the code processing result comprising a code adjustment result, update the target code file based on the code adjustment result; or
in response to the code processing result comprising a code repair strategy, repair the target code file according to the code repair strategy; or
after determining that the code processing result is invalid, the processor is further configured to:
in response to the target code file being the newly added code file, delete the target code file; or
in response to the target code file being the original code file, maintain the target code file unchanged.

18. The electronic device of claim 11, wherein the processor is further configured to:
in response to the code processing task meeting a preset condition, add a new code file and take a newly added code file as the target code file; or
in response to the code processing task not meeting the preset condition, determine the target code file from a plurality of original code files.

19. The electronic device of claim 25, wherein the processor is further configured to:
in response to the code processing task comprising at least one of generating a test code or adding a code template, determine that the code processing task meets the preset condition; or
determine a search parameter of the target code file based on the first dialog text and determine the target code file from the plurality of original code files based on the search parameter.

20. A non-transitory computer-readable storage medium storing computer instructions, wherein the computer instructions are configured to cause a computer to implement a method for processing a code based on a large model in a human-machine interaction system, the method comprising:
obtaining a first dialog text for describing a code processing task;
determining at least one of a newly added code file or an original code file as a target code file corresponding to the code processing task;
inputting the first dialog text into a large model, and outputting, via the large model, a code processing result of the target code file and a second dialog text corresponding to the first dialog text; and
displaying the code processing result and a target dialog text on an interaction interface, wherein the target dialog text comprises at least one of the first dialog text or the second dialog text.
